(19) United States
(12) Patent Application Publication
(10) Pub. No.: US 2024/0211725 A1
(43) Pub. Date: Jun. 27, 2024

(54) A Quantum Neural Network for Noisy Intermediate Scale Quantum Devices

(71) Applicant: Telefonaktiebolaget LM Ericsson (publ), Stockholm (SE)

(72) Inventors: Ahsan Javed Awan, Vallentuna (SE); Altay Dikme, Stockholm (SE)

(21) Appl. No.: 18/576,213

(22) PCT Filed: Nov. 30, 2021
(86) PCT No.: PCT/SE2021/051186

§ 371 Date: Jan. 3, 2024

Related U.S. Application Data
(60) Provisional application No. 63/221,146, filed on Jul. 13, 2021.

(51) Int. Cl. G06N 3/04; G06N 10/20

(52) U.S. Cl. CPC G06N 3/04; G06N 10/20

(57) ABSTRACT

A computing system (110) encodes input data into a plurality of physical qubits using an encoding circuit (10) of a Quantum Neural Network. QNN (50). The encoding circuit (10) comprises a Y-rotation gate (60) directly followed by a phase gate (70) and has a circuit depth of two. The computing system (110) executes a variational ansatz circuit (20) on the physical qubits to generate a classification prediction for at least some of the input data. The variational ansatz circuit (20) comprises a plurality of parameterized gates.

### TECHNICAL FIELD

The present disclosure generally relates to the field of quantum computing and, more particularly, to efficiently generating a classification prediction using quantum computing techniques.

### BACKGROUND

Classification problems are one of the challenging problems in Radio Access Networks (RAN). For example, the use of a binary classification method to determine the best available frequencies when users are close to cell edges may provide faster handover action with a potential for reducing drop rates. Such an approach can also be used for classification of microwave link degradation. Deep neural networks are increasing becoming popular to solve classification problems in a RAN. However, these networks require significant Graphics Processing Unit (GPU) resources and long training times. Thus, entirely new methods may be required to speed up the training or evaluation of neural networks.

Quantum computers have the potential to solve certain computationally intractable problems in a shorter period by exploiting the quantum mechanical concepts such as superposition and entanglement. Indeed, algorithms based on quantum phenomena may improve upon the classical algorithms currently used in neural networks. Different variants of quantum circuits have been proposed as Quantum Neural Networks (QNNs), as well as their relation to classical neural networks, associated issues, and proposed solutions. However, most proposals are not feasible to run on a Noisy Intermediate Scale Quantum (NISQ) device, as the devices are still in the infancy of their development and lack efficient quantum error correction techniques. QNN algorithms that are practical for use with NISQ devices (and not only on ideal simulators) remain elusive in the known art.

### SUMMARY

Embodiments of the present disclosure are generally directed to enhancing QNNs for increased compatibility with a broader array of computing platforms. In this regard, particular embodiments of the present disclosure provide a QNN classification circuit that is suitable for use on an NISQ device.

Embodiments of the present disclosure include a method implemented by a computing system. The method comprises encoding input data into a plurality of physical qubits using an encoding circuit of a Quantum Neural Network (QNN). The encoding circuit comprises a Y-rotation gate directly followed by a phase gate. The encoding circuit has a circuit depth of two. The method further comprises executing a variational ansatz circuit on the physical qubits to generate a classification prediction for at least some of the input data. The variational ansatz circuit comprises a plurality of parameterized gates.

In some embodiments, the method further comprises encoding the input data into the plurality of physical qubits comprises encoding two features of the input data for each qubit in the plurality of physical qubits.

In some embodiments, the method further comprises reducing a dimensionality of the input data such that a circuit depth of the variational ansatz circuit is reduced below a suitability threshold. In some such embodiments, the suitability threshold is a circuit depth threshold over which the variational ansatz circuit has a coherence requirement on the physical qubits that cannot be met by a Noisy Intermediate Scale Quantum (NISQ) device.

In some embodiments, the method further comprises constructing the variational ansatz circuit by combining a first variational ansatz circuit and a second variational ansatz circuit. In some such embodiments, the variational ansatz circuit has a higher expressibility than each of the first and second variational ansatz circuits individually. Additionally or alternatively, in some embodiments the variational ansatz circuit has a higher entangling capability than each of the first and second variational ansatz circuits individually.

In some embodiments, the method further comprises training the QNN to enhance a plurality of parameters used by the parameterized gates of the variational ansatz circuit to generate the classification prediction. In some such embodiments, training the QNN to enhance the plurality of parameters used by the parameterized gates of the variational ansatz circuit comprises iteratively updating the parameters using a gradient descent to reduce a cost of the parameters. In some such embodiments, the gradient descent comprises not more than three hyperparameters.

In some embodiments, the computing system comprises an NISQ device.

Other embodiments include a computing system comprising processing circuitry and a memory. The memory contains instructions executable by the processing circuitry whereby the computing system is configured to encode input data into a plurality of physical qubits using an encoding circuit of a Quantum Neural Network (QNN), the encoding circuit comprising a Y-rotation gate directly followed by a phase gate. The encoding circuit has a circuit depth of two. The computing system is further configured to execute a variational ansatz circuit on the physical qubits to generate a classification prediction for at least some of the input data. The variational ansatz circuit comprises a plurality of parameterized gates.

In some embodiments, the computing system is further configured to perform any one of the methods described above.

Other embodiments include a computer program comprising instructions which, when executed on processing circuitry of a computing system, cause the processing circuitry to carry out any one of the methods described above.

Yet other embodiments include a carrier containing such a computer program. The carrier is one of an electronic signal, optical signal, radio signal, or computer readable storage medium.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a variational ansatz circuit 20, generally, as opposed to discussion of particular instances of variational ansatz circuits 20a, 20b).

FIG. 1 is a schematic illustrating an example computing device, according to one or more embodiments of the present disclosure.

FIG. 2 is a flow diagram of an example method of training a QNN, according to one or more embodiments of the present disclosure.

FIG. 3 is a schematic block diagram illustrating an example encoding circuit, according to one or more embodiments of the present disclosure.

FIG. 4 and FIG. 5 are schematic block diagrams illustrating example variational ansatz circuits, according to particular embodiments of the present disclosure.

FIG. 6 is a table illustrating features of ansatzes that use different numbers of qubits, according to one or more embodiments of the present disclosure.

FIG. 7 is a table illustrating results of experimental evaluations of example variational ansatz circuits, according to particular embodiments of the present disclosure.

FIG. 8 is a flow diagram of an example method of choosing a circuit structure for a QNN, according to one or more embodiments of the present disclosure.

FIG. 9 is a flow diagram of an example method of training a QNN, according to one or more embodiments of the present disclosure.

FIG. 10 is a flow diagram of an example method of testing a QNN, according to one or more embodiments of the present disclosure.

FIG. 11 is a flow diagram of an example method of generating a classification prediction using a QNN, according to one or more embodiments of the present disclosure.

FIG. 12 is a schematic block diagram illustrating an example computing device, according to one or more embodiments of the present disclosure.

### DETAILED DESCRIPTION

Embodiments of the present disclosure provide QNN algorithms having a shorter circuit depth relative to traditional QNN algorithms, thereby enhancing their practical use on NISQ devices. Existing quantum solutions of performing classification have been verified using perfect simulations of quantum computers. However, these approaches do not accurately describe the results one may expect if using an NISQ device. This is because simulators do not consider noise models and are also limited to a small number of qubits due to the processing power required to simulate a quantum computer using a classical computer. Currently, NISQ computers are available for use, but are limited by the coherence time of qubits. This greatly restricts the number of gates that are available for use in a given quantum circuit. That is, according to traditional solutions, the circuit depth must be small in order to gather results that are not affected by decoherence errors.

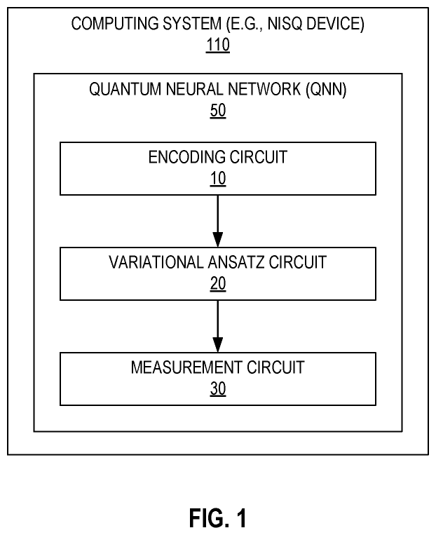

FIG. 1 illustrates a computing system 110 (e.g., an NISQ device) configured to execute a QNN 50 according to at least some embodiments of the present disclosure. The QNN 50 in this example comprises three circuit blocks. The first block is the encoding circuit 10. The encoding circuit 10 encodes classical data into physical qubits. The next block is the variational ansatz circuit 20, which is variable and generally comprises a layer of single qubit gates followed by a layer of controlled two-qubit gates in some configuration. The gates of the variational ansatz circuit 20 are parametrized. Generally, it is desirable to find an optimum for these parameters. The third block is the measurement circuit 30. In general, this provides a measurement of the first qubit.

Ideally, when encoding classical data into physical qubits, one wishes to retain as much of the original data as possible while also keeping the circuit depth of the encoding circuit 10 to a minimum. Current encoding schemes such as Amplitude Encoding, Basis Encoding, and Angle encoding are all problematic in some way. For example, some such encoding schemes have too long of a circuit depth or are deficient feature-wise. There is also evidence that the choice of data encoding scheme can play a role in the type of decision boundary that classification tasks can result in.

Thus, when selecting an encoding scheme for a QNN classification task, the choice of encoding plays a large role in not only the feasibility of executing the circuit on NISQ devices but also the potential prediction of the classifier. The most popular encoding scheme used for QNN classification is currently Amplitude Encoding, which can theoretically encode 2n dimensional data using n qubits. The main problem with this approach however is that the encoding circuit will have a circuit depth of at least 2n. This makes Amplitude Encoding infeasible for use in NISQ devices as the encoding process of data itself is already too large for the device to handle properly. Thus, other encoding solutions are required when attempting to encode data for classification tasks on NISQ devices.

Other encoding schemes such as Basis Encoding and Angle Encoding simply encode one feature of the data per qubit, and therefore require many qubits for larger dimensional data. This is also an issue in NISQ devices as the number of qubits in such devices are limited, and because an increase in qubits may increase the circuit depth of the variational ansatz circuit 20, depending on what type of ansatz is used.

In absence of error mitigation implemented in quantum computers in the near-term (e.g., at the gate level, at the measurement phase, etc.), a reduction in circuit depth may improve the quality of results obtained from NISQ devices. Embodiments of the present disclosure provide a short depth QNN 50 using an alternative encoding scheme for the encoding circuit 10 called Dense Angle encoding. This encoding circuit 10 has the advantage of encoding two features per qubit. This is done by making use of the two degrees of freedom of the Bloch Sphere. The procedure has a set circuit depth of 2, i.e., requiring two gates. The number of qubits required to encode N-dimensional data under such a scheme is, therefore, N/2 since each qubit encodes two features.

Particular embodiments of the present disclosure also combine Dense Angle encoding with a suitable choice of variational ansatz. The variant of variational ansatz may be selected to increase (e.g., maximize) the expressibility and entanglement capability of the ansatz, while keeping the circuit depth low (e.g., at a minimum). One particular way in which expressibility is quantified is by an extent to which a parameterized quantum circuit is able to generate states from the Hilbert space. Entanglement capability may, for example, be quantified using the Meyer-Wallach measure. The resulting combination of Dense Angle encoding and a suitable variational ansatz provides a QNN 50 having a short-depth circuit that is practical for use on, e.g., an NISQ device.

Yet further embodiments of the present disclosure additionally or alternatively select a momentum gradient descent, e.g., to achieve a good tradeoff between the number of hyperparameters and performance during the optimization subroutine of updating parameters.

In some embodiments, the resultant encoding scheme yields predetermined gates and circuit depth, which saves computational time as a determination of the circuit for, e.g., amplitude encoding need not be performed. Such an encoding approach can be a compromise between two or more previously mentioned encoding methods, for example. Furthermore, embodiments may avoid requiring expensive two-qubit gates. Notwithstanding, particular embodiments of the present disclosure, when working with data of large dimensions, may require some sort of dimensionality reduction.

According to particular embodiments, by providing an encoding scheme which works for a QNN classifier and reduces the required number of qubits while retaining a constant circuit depth, a short depth QNN classifier can be used on one or more NISQ devices.

When looking at the encoding part of the overall circuit, the Dense Angle encoding scheme proposed herein may be particularly advantageous as compared with other popular schemes of amplitude encoding (e.g., in terms of circuit depth). The circuit depth of the Dense Angle encoding circuit 10 is constant at 2, whereas the amplitude encoding circuit in known approaches have depth of at least order 2n where n is the number of qubits. This was verified experimentally using 256 dimensional data, in which case the depth of Dense Angle encoding was 2 (as previously mentioned), whereas amplitude encoding had a depth of 503. NISQ devices simply cannot run such long depth circuits due to shorter decoherence times.

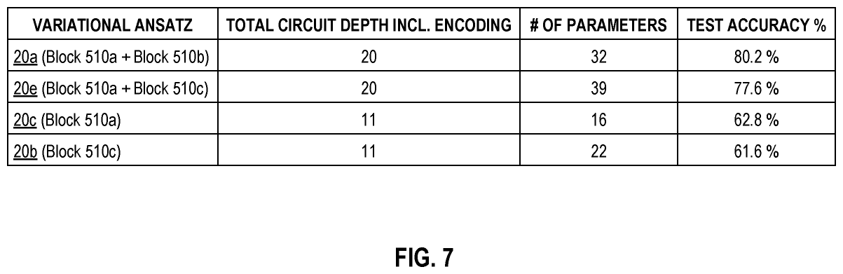

The results of an experimentally constructed QNN 50 with Dense Angle encoding combined with a suitable low-depth ansatz is shown in the table of FIG. 7, which will be discussed in greater detail below. Using a circuit with a total depth of 20 (including the encoding circuit 10 and variational ansatz circuit 20), and 32 parameters, a test accuracy of 80.2% was experimentally achieved. These results can be improved upon by increasing the size of the training data set, performing a hyperparameter search, and/or by potentially using another optimization routine such as an Adam optimizer instead of using momentum gradient descent. All of these improvements may be accomplished without changing the depth of the QNN 50, which in turn retains the ability to run on an NISQ device. Although other QNN methods may achieve higher test accuracy compared to one or more of the embodiments disclosed herein, such alternative methods do not have a short depth, and are therefore not feasible for use on an NISQ device.

To be clear, a QNN 50 is a parametrized quantum circuit, which is defined as a tunable unitary operation U(θ) on N qubits that is applied to some quantum state |ψ [symbol] . In general, this quantum state is the resulting state after applying the encoding scheme of the encoding circuit 10 on the ground state |0 [symbol] ^{⊗}^{^{N}}. After applying the unitary operation on the quantum state |ψ [symbol] , the resulting state is:

$$\vert ϕ 〉 = U ( θ ) \vert ψ 〉 \qquad ( 1 )$$

where θ is a vector of circuit parameters.

The structure of the QNN 50 may be described in three steps: 1) apply the encoding circuit 10 to the ground state; 2) apply the variational ansatz circuit 20 to the encoded state; and 3) apply the measurement circuit 30 on a qubit (e.g., the first qubit).

Expressed differently, the QNN 50 may include applying an encoding circuit S(x) to the ground state |0 [symbol] ^{⊗}^{^{N}} resulting in:

$${\vert ψ 〉 = S ( x ) \vert 0 〉}^{{⊗}_{N}} \qquad ( 2 )$$

The QNN 50 may further include applying the variational ansatz U(θ) to the encoded state |ψ [symbol] resulting in:

$$\vert ϕ 〉 = U ( θ ) \vert ψ 〉 . \qquad ( 3 )$$

The QNN 50 may further include applying a measurement gate on the first qubit.

Particular embodiments of the present disclosure include a combination of an encoding scheme that results in an encoding circuit S(x) with depth=2, and a variety of variational ansatzes with varying circuit depths and numbers of parameters. Overall, the circuit depth is kept low (e.g., to a minimum) which allows for use on one or more NISQ devices.

Once circuits for each data point are prepared, the prediction is read out from the final state by measuring the first qubit in the computational basis. The expectation value can be written as:

$$𝔼 ( {σ}_{z} ) = 〈 ϕ \vert {U}^{†} ( θ ) ( {σ}_{z} ⊗ 𝕀 ⊗ … ⊗ 𝕀 ) U ( θ ) \vert ϕ 〉 \qquad ( 4 )$$

for the given data point. Thresholding the value yields binary output which is the prediction of the model, as follows:

$$f ( x , θ ) = \{ \begin{matrix}1 & if 𝔼 ( {σ}_{z} ) > 0 \\ - 1 & if 𝔼 ( {σ}_{z} ) < 0\end{matrix} \qquad ( 5 )$$

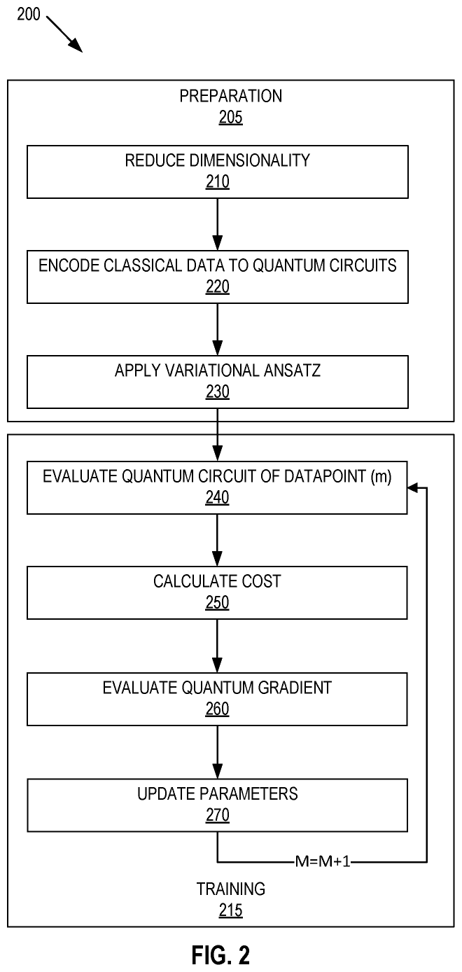

A hybrid quantum-classical stochastic gradient descent algorithm is used to train the QNN 50. FIG. 2 illustrates an example method 200, in accordance with particular embodiments. The method 200 comprises a preparation phase 205 and a training phase 215, either or both of which may be implemented by a computing system 110 that comprises one or more classical devices (e.g., executing a simulation of a quantum environment) and/or one or more quantum computing devices (e.g., an NISQ device).

According to the method 200, the preparation phase is performed first (block 205). In the preparation phase, classical data is first preprocessed by reducing the dimension of the data to some dimension decided by the user, keeping in mind the limitations of the NISQ device or simulator (block 210). The dimensions of a Modified National Institute of Standards and Technology (MNIST) dataset was experimentally reduced from 28×28 to 4×4, for example. Next, the classical data is encoded to quantum circuits (block 220), and the variational ansatz is applied to each circuit (block 230).

Once the circuits are prepared the training process can be performed (block 215). The training process uses a dataset, D, that includes pairs of training inputs x^{m} ∈χ and y^{m} ∈ [symbol] for m=1, . . . , M number of datapoints, such that:

$$𝒟 = \{ ( {x}^{1} , {y}^{1} ) , … , ( {x}^{M} , {y}^{M} ) \} \qquad ( 6 )$$

The goal of the training is to be able to predict the output y of a new input x (block 240). This example will focus on the case of a binary classification task in which χ= [symbol] ^{N} and [symbol] ={−1, 1}. In this example, a least-squares objective is used to evaluate the cost of a certain configuration of parameters θ, expressed as follows:

$$𝒞 ( θ , 𝒟 ) = \frac{1}{2} {\sum }_{m = 1}^{M} {\vert 𝔼 ( {σ}_{z} , {x}^{m} ) - {y}^{m} \vert}^{2} \qquad ( 7 )$$

The evaluation seeks to minimize the total cost. A stochastic gradient descent approach is used, where the entire training set D is not considered in each iteration, but rather a single data point per iteration is evaluated. In other words, a single-batch gradient descent is performed (block 250). The cost of each iteration can therefore be written as:

$$𝒞 ( θ , ℬ ) = \frac{1}{2} {\vert 𝔼 ( {σ}_{z} , {x}^{m} ) - {y}^{m} \vert}^{2} \qquad ( 8 )$$

The cost is minimized by gradient descent which updates each parameter θ by the update rule:

$${θ}^{( t )} = {θ}^{( t - 1 )} - η \frac{\partial 𝒞 ( θ , ℬ )}{\partial θ} \qquad ( 9 )$$

The gradient of the cost function,

$$\frac{\partial ( θ , ℬ )}{\partial θ} ,$$

is given by:

$$\frac{\partial 𝒞 ( θ , ℬ )}{\partial θ} = ( 𝔼 ( {σ}_{z} , {x}^{m} ) - {y}^{m} ) ( {\partial }_{θ} 𝔼 ( {σ}_{z} , {x}^{m} ) ) \qquad ( 10 )$$

This, in turn, includes the derivative of the circuit ∂_{θ} [symbol] (σ_{z}, x^{m}). There are several ways of evaluating the quantum gradient, e.g., using a classical linear combination of unitaries and a parameter shift approach. The gradient can be evaluated analytically and may be performed by classical simulation (block 260).

Once the gradient is calculated, the parameters are updated and the process of evaluating the circuit of the next datapoint with updated parameters is repeated (block 270). In view of the above, the training phase (block 215) of the method 200 may be summarized as:

1. Evaluate quantum circuit of datapoint m (block 240).

2. Calculate cost C (θ, [symbol] ) using prediction from previous datapoint (block 250).

3. Evaluate quantum gradient of the given quantum circuit (block 260).

4. Update parameters θ using gradient update rule (block 270).

5. Repeat training phase (block 215) on next datapoint m+1.

In some embodiments, the stochastic gradient descent optimization may be performed using an approach known as momentum gradient descent. Momentum gradient descent adds a momentum term to the stochastic gradient optimization, with hyperparameter m. This leads to a faster convergence to the cost minima, but adds one hyperparameter to be tuned. This approach is a good trade-off between classification accuracy versus the number of hyperparameters. The optimization step may, e.g., be as follows:

$${θ}^{( t )} = {θ}^{( t - 1 )} - {a}^{( t )} \qquad ( 11 )$$

$${a}^{( t )} = {ma}^{( t - 1 )} + η \frac{\partial 𝒞 ( θ , ℬ )}{\partial θ} \qquad ( 12 )$$

That said, other embodiments may include other optimization techniques, such as those having demonstrated good results on classical neural networks. For example, in some embodiments, an Adam optimizer is used. An Adam optimizer has an adaptive learning rate and stores exponentially decaying averages of past squared gradients. This optimizer has three hyperparameters which require tuning. Accordingly, a hyperparameter search can be time consuming. For the Adam optimizer the optimization step may be expressed as:

$${θ}^{( t )} = {θ}^{( t - 1 )} - {η}^{( t )} \frac{{a}^{( t )}}{\sqrt{{b}^{( t )}} + ϵ} \qquad ( 13 )$$

$${a}^{( t )} = \frac{{β}_{1} {a}^{( t - 1 )} + ( 1 - {β}_{1} ) ∇ 𝒞 ( θ , ℬ )}{( 1 - {β}_{1}^{t} )} \qquad ( 14 )$$

$${b}^{( t )} = \frac{{β}_{2} {b}^{( t - 1 )} + ( 1 - {β}_{2} ) {( ∇ 𝒞 ( θ , ℬ ) )}^{{⊙}_{2}}}{( 1 - {β}_{2}^{t} )} \qquad ( 15 )$$

$${η}^{( t )} = {η}^{( t - 1 )} \frac{\sqrt{( 1 - {β}_{1}^{t} )}}{( 1 - {β}_{2}^{t} )} \qquad ( 16 )$$

where (∇C(θ, [symbol] ))^{⊙2} denotes the elementwise squaring of the gradient. This optimizer has three hyperparameters β₁, β₂ and ∈.

Dense Angle encoding is performed on an input vector of classical information. The vector may be expressed as:

$$\vec{x} = [ \begin{matrix}{x}_{1} \\ ⋮ \\ {x}_{N}\end{matrix} ] ∈ {ℝ}^{N} \qquad ( 17 )$$

The vector is encoded by mapping the input vector to a quantum state:

$$\vert x 〉 = {⊗}_{j = 1}^{N / 2} cos ( π {x}_{2 j - 1} ) \vert 0 〉 + {e}^{2 π {ix}_{2 j}} sin ( π {x}_{2 j - 1} ) \vert 1 〉 \qquad ( 18 )$$

According to a simple example in which \vec{x} ∈ [symbol] ², the quantum state may be expressed simply as:

$$\vert x 〉 = cos ( π {x}_{1} ) \vert 0 〉 + {e}^{2 π {ix}_{2}} sin ( π {x}_{1} ) \vert 1 〉 \qquad ( 19 )$$

A quantum circuit is then constructed that can map an input to the quantum state described in Equation 18. The parametrized Y-rotation gate acting on the ground state results in the following state:

$${R}_{Y} ( θ ) \vert 0 〉 = cos θ / 2 \vert 0 〉 + sin θ / 2 \vert 1 〉 \qquad ( 20 )$$

The single qubit rotation about the Z-axis is given by the phase gate:

$$P ( ϕ ) = [ \begin{matrix}1 & 0 \\ 0 & {e}^{i ϕ}\end{matrix} ] \qquad ( 21 )$$

Applying the phase gate on the state given in Equation 20 gives:

$$P ( ϕ ) {R}_{Y} ( θ ) \vert 0 〉 = cos θ / 2 \vert 0 〉 + {e}^{i ϕ} sin θ / 2 \vert 1 〉 \qquad ( 22 )$$

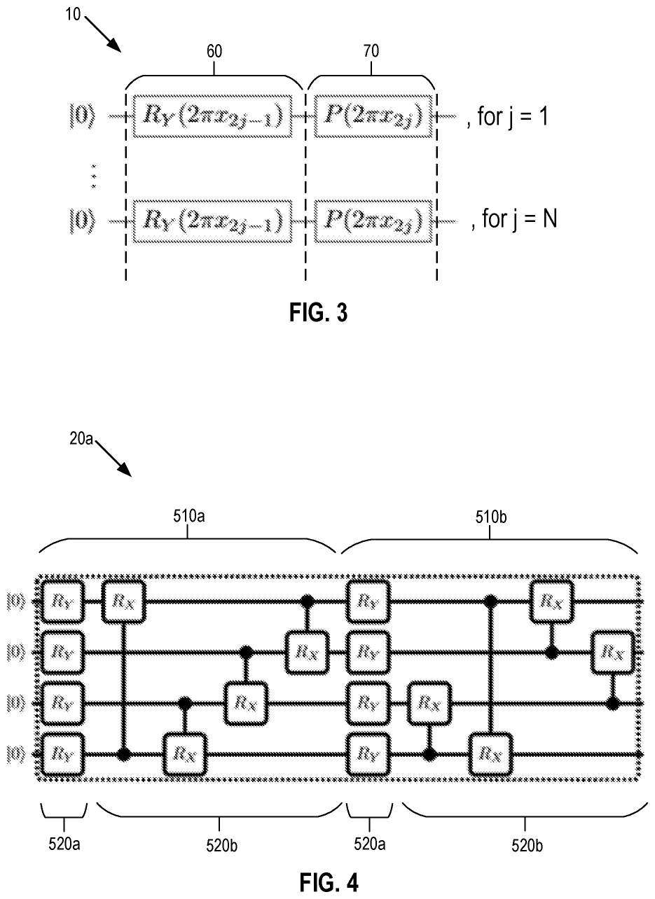

From the above, it can be observed that setting θ=2πx₁ and ϕ=2πx₂ gives the single qubit case of Equation 18. Thus, encoding classical data to physical qubits can be performed by using a Y-rotation gate 60 followed by a phase gate 70, as shown in FIG. 3. In particular, the first two features may be encoded to the first qubit, the next set of two features may be encoded onto the second qubit, and so on. This allows N features to be encoded using N/2 qubits with a constant gate depth of 2.

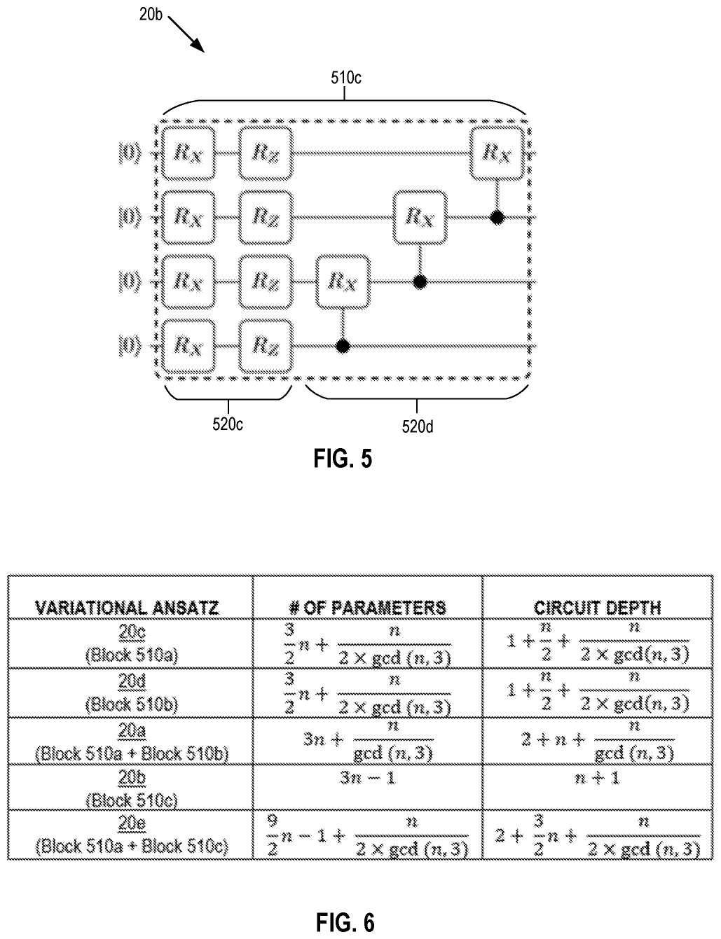

As mentioned earlier, the choice of variational ansatz may also be important for the classification performed by the QNN 50. In this regard, a variant of ansatz that can reach a large portion of the Hilbert space while maintaining a circuit depth that is as small as possible or practical is advantageous. Accordingly, a variational ansatz circuit 20 with high expressibility and entangling capability while also retaining a low circuit depth is recommended for use in at least some of the present embodiments. In this regard, the example variational ansatz circuits 20 of FIG. 4 and FIG. 5 have been experimentally identified as being suitable.

In FIG. 4, the variational ansatz circuit 20a comprises two blocks 510a, 510b. The first block 510a comprises a first collection of single and two qubit gates. The second block 510b comprises a second collection of single and two qubit gates.

Each block 510a, 510b comprises two layers 520a, 520b. The first layer 520a is a layer of parametrized single qubit Ry gates. The second layer 520b consists of controlled two qubit unitary CRx gates. When a new block is added the gates in the second layer 520b change. In particular, the target and controls are swapped and the leftmost two qubit gate rotates clockwise in the circuit diagram.

In FIG. 5, the variational ansatz circuit 20b comprises a layer 520c of two single qubit gates Rx and Rz followed by a layer 520d of controlled two qubit CRₓ gates.

Different constellations for variational ansatz circuits 20a-e were experimentally evaluated, the results of which are shown in the table of FIG. 6. In particular, the table in FIG. 6 shows the respective number of parameters and circuit depth of various blocks 510 when used in different variational ansatz circuits 20a-e in a QNN 50. The number of qubits is given by the variable n. The plus sign (i.e., “+”) is used to represent a concatenation of two blocks 510.

The efficiency of a low-depth circuit for classification purposes may be shown using QNNs 50 with various ansatzes to classify numerical digits from the MNIST dataset. To do so, experiments were performed in which two digits to classify were chosen in order to convert the classification task into a binary classification. In this experiment, the digits 0 and 1 were chosen to be classified. Next, a subset of 2000 images were randomly chosen as a training set, and a subset of 500 other images were randomly chosen as a test set.

The MNIST dataset included 28×28 images which, when flattened into a vector, would result in a 784-dimensional vector. To reduce the dimensionality of the images, 6 pixels were removed from each edge of each image resulting in a dimensional reduction from 28×28 to 16×16. Next, every other row and every other column were removed, resulting in an 8×8 image for each image. Next, bilinear interpolation was performed to further reduce the dimension to 4×4 (e.g., using the Tensorflow command “tensorflow.image.resize”). When flattened this resulted in a 16-dimensional vector that is encodable using 8 qubits through Dense Angle encoding.

After the images were resized, different variational ansatz circuits 20 were prepared, e.g., as discussed above, and training is performed, e.g., the training phase 215 as discussed above with respect to FIG. 2. For the training procedure, a learning rate of η=0.05 and momentum m=0.9. Once training was completed, the accuracy of the QNN 50 was tested on the test set with the parameters obtained from the training procedure. Particular results obtained by experimentally analyzing the different variational ansatz circuits 20a-c and 20e are shown in the table of FIG. 7.

As previously mentioned, Dense Angle encoding encodes two features per qubit, using a constant circuit depth of 2. In practice, this typically requires that some sort of dimensionality reduction be performed. A particular example in which dimensionality was reduced to 4×4 resulting in 16 dimensional data was provided above, which required 8 qubits to encode using Dense Angle encoding.

These results were experimentally verified to be advantageous over traditional approaches, such as amplitude encoding. For example, a dimensional reduction from 28×28 to 16×16 (resulting in 256-dimensional data) has been performed to prepare data for Amplitude Encoding. Amplitude encoding is able to encode this 256-dimensional data using 8 qubits, as amplitude encoding encodes 2ⁿ features per qubit (i.e., 2⁸=256). However, to encode in this way requires a gate depth of at least 256 as well. In practice, when the built in initialization function QuantumCircuit.initialize in IBM's quantum Software Development Kit (SDK) qiskit was experimentally used, the resulting circuit depth was 503. Thus, the circuit depth was far in excess of the results obtained using the Dense Angle encoding proposed herein (e.g., as shown in FIG. 7).

Thus, in practice, using Amplitude Encoding results in circuit depths that make running the circuit infeasible on many platforms. Despite losing information by having to reduce the dimensions of the data to a greater degree relative to certain known techniques, Dense Angle encoding is superior in terms of near term accessibility, and provides a QNN 50 that is practical for use on, e.g., an NISQ device.

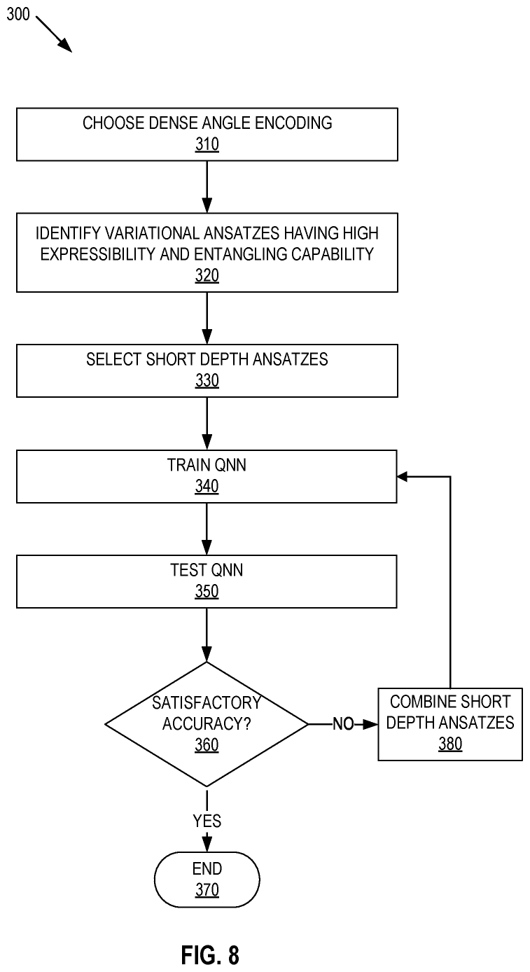

In view of the above, FIG. 8 illustrates a method 300 of selecting a circuit structure for a QNN classifier. As previously mentioned, a combination of Dense Angle encoding with short depth ansatzes are recommended for compatibility with an NISQ device. The method 300 comprises choosing Dense Angle encoding for the encoding circuit 10 of the QNN 50 (block 310). As noted above, Dense Angle encoding provides a circuit depth of 2.

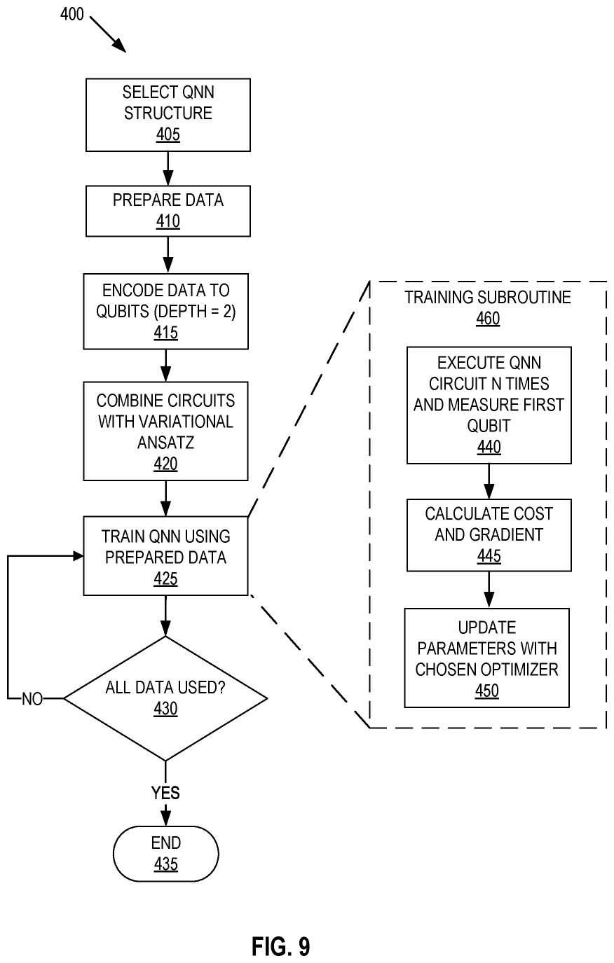

The method 300 further comprises identifying a plurality of variational ansatzes that each have high expressibility and entangling capability (block 320). The method 300 further comprises selecting a plurality of short depth ansatzes, e.g., from the plurality of variational ansatzes (block 330). The method 300 further comprises training the QNN 50 (e.g., as discussed above with respect to FIG. 2 or below with respect to FIG. 9) (block 340) and testing the QNN 50 using one or more of the selected short depth ansatzes (block 350).

The method 300 further comprises evaluating the accuracy of the tested ansatzes (block 360). In this regard, an ansatz may be determined to have satisfactory accuracy in response to the accuracy exceeding a threshold, for example. If an ansatz is determined to have satisfactory accuracy (block 360, yes path), the method 300 ends (block 370). Otherwise (block 370, no path), the method 300 comprises combining a plurality of the short depth ansatzes (block 380), and training the QNN 50 using the combination (block 340). The training (block 340), testing (block 350) and evaluating (block 360) may be performed repeatedly until a combined short depth ansatz is identified that has satisfactory accuracy (block 360, yes path).

FIG. 9 illustrates another example method 400 of training a QNN 50. In view of the above examples, the method 400 comprises selecting a structure for the QNN 50 (e.g., as described above with respect to FIG. 8) (block 405) and preparing the data on which the QNN 50 will operate (e.g., as discussed above with respect to FIG. 2) (block 410). The method 400 further comprises encoding the data into qubits having a circuit depth of 2 (block 415) and combining circuits with variational ansatz (block 420).

The method 400 further comprises iteratively training the QNN 50 with datapoints from the prepared data to enhance the parameters of the variational ansatz (block 425 and block 430, no path) until the QNN 50 has been trained with all the datapoints in the prepared data (block 430, no path). The method 400 ends once each of the datapoints in the prepared data has been used to train the QNN (block 430, yes path and block 435).

Training the QNN 50 may, in some embodiments, include the training subroutine 460. The training subroutine 460 comprises executing the QNN circuit n times and measuring the first qubit (block 440). The training subroutine 460 further comprises calculating cost and gradient (block 445) and updating parameters with a chosen optimizer (block 450). Other embodiments may additionally or alternatively include one or more aspects of the training procedures discussed above (e.g., with respect to FIG. 2).

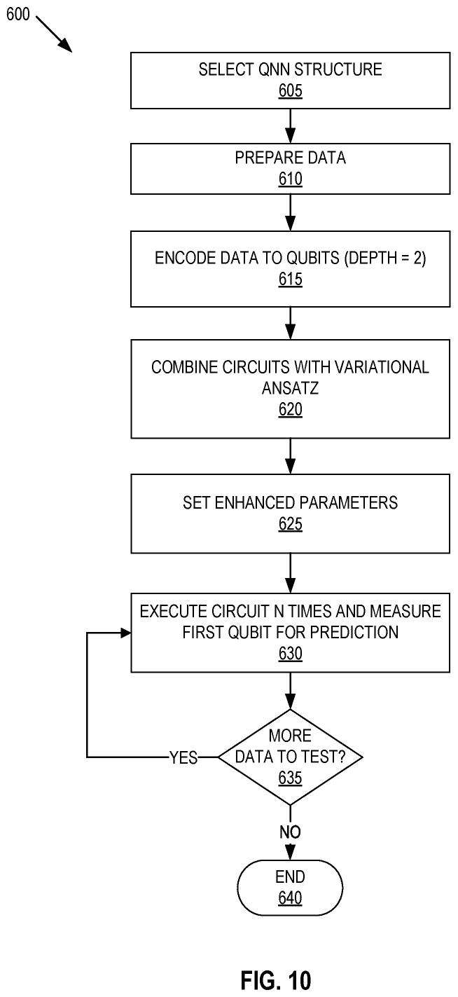

FIG. 10 illustrates a method 600 of testing the QNN 50. In view of the above examples, the method 600 comprises selecting a structure for the QNN 50 (block 605) and preparing the data on which the QNN 50 will operate (e.g., as discussed above with respect to FIG. 2) (block 610). The method 600 further comprises encoding the data into qubits having a circuit depth of 2 (block 615) and combining circuits with variational ansatz (block 620).

The method 600 further comprise setting the parameters to be used in evaluating the data to those which have been enhanced through some training procedure, e.g., as discussed above (block 625). The method 600 further comprises executing the circuit n times against one or more data and measuring the first qubit to make a classification prediction (e.g., a classification of the data as discussed above) (block 630). The method 600 further comprises checking whether there is more data to test, and if so (block 635, yes path), executing the circuit n times against one or more further data and measuring the first qubit to make a classification prediction with respect to this further data (block 630). Once classification predictions have been made for all the data (block 635, no), the method 600 ends (block 640).

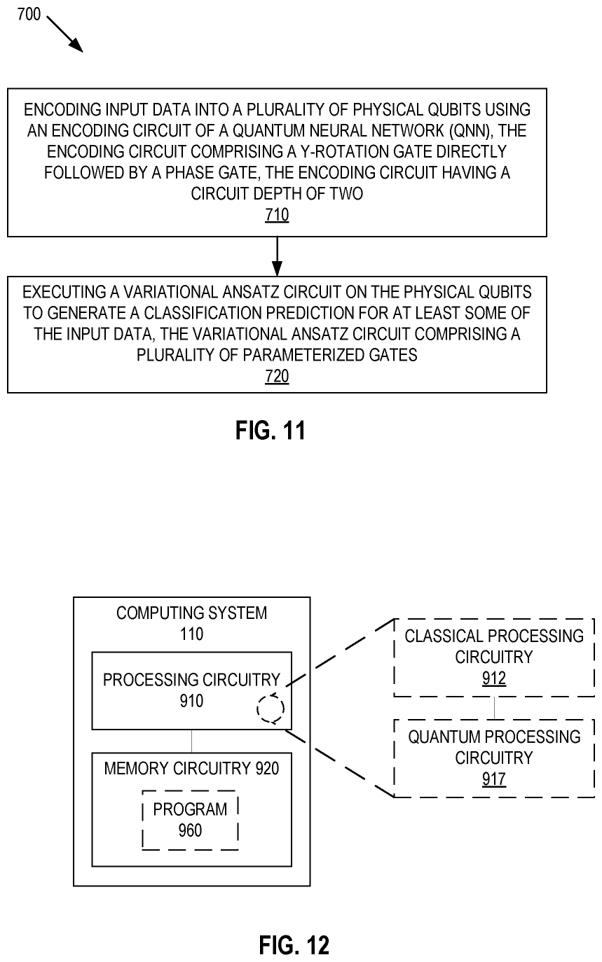

A further example method 700 according to particular embodiments is illustrated in FIG. 11. The method 700 comprises encoding input data into a plurality of physical qubits using an encoding circuit 10 of a QNN 50, the encoding circuit 10 comprising a Y-rotation gate 60 directly followed by a phase gate 70, the encoding circuit 10 having a circuit depth of two (block 710). The method 700 further comprises executing a variational ansatz circuit 20 on the physical qubits to generate a classification prediction for at least some of the input data (block 720). The variational ansatz circuit comprising a plurality of parameterized gates.

Other embodiments of the present disclosure include a computing system 110. The computing system 110 may perform one, some, or all of the functions described above, depending on the embodiment. In particular, the computing system 110 may be configured to perform any one or more of the methods 200, 300, 400, 600, 700 described above.

In one example, the computing system 110 is implemented according to the hardware illustrated in FIG. 12. The example hardware of FIG. 12 comprises processing circuitry 910 and memory circuitry 920. The processing circuitry 910 is communicatively coupled to the memory circuitry 920, e.g., via one or more buses. The processing circuitry 910 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof.

In some embodiments, the processing circuitry 910 comprises a first processing circuit and a second processing circuit that are capable of executing functions in parallel and/or in series. For example, the processing circuitry 910 may comprise classical processing circuitry 912 and/or quantum processing circuitry 917. In some such embodiments, one or more particular functions are performed on the classical processing circuitry 912, whereas one or more other functions are performed on the quantum processing circuitry 917. Accordingly, particular embodiments may take advantage of the classical and quantum processing capabilities of the computing system 110 as is appropriate for the particular computing system 110 provided. According to one particular example, execution of the QNN 50 and qubit measurement (e.g., as in FIG. 9, block 440) may be performed on the quantum processing circuitry 917, whereas calculation of the cost and/or gradient (e.g., as in FIG. 9, block 445) may be performed on the classical processing circuitry 912. Other embodiments include other balancing of the execution of particular tasks on the quantum processing circuitry 917 and classical processing circuitry 912 as appropriate.

The processing circuitry 910 may be programmable hardware capable of executing software instructions stored, e.g., as a machine-readable computer program 960 in the memory circuitry 920. The memory circuitry 920 may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

According to particular embodiments of the hardware illustrated in FIG. 12, the processing circuitry 910 is configured to perform the method 700 illustrated in FIG. 11. That is, the processing circuitry 910 is configured to encode input data into a plurality of physical qubits using an encoding circuit 10 of a QNN 50. The encoding circuit 10 comprises a Y-rotation gate 60 directly followed by a phase gate 70. The encoding circuit 10 has a circuit depth of two. The processing circuitry 910 is further configured to execute a variational ansatz circuit 20 on the physical qubits to generate a classification prediction for at least some of the input data. The variational ansatz circuit 20 comprises a plurality of parameterized gates.

The various embodiments disclosed herein provide a variety of technical advantages over conventional techniques. For example, particular embodiments advantageously save computational time over alternative encoding schemes through the use of predetermined gates and/or circuit depth. Particular embodiments may additionally or alternatively be implemented more cheaply than alternatives that require expensive two-qubit gates. Notably, particular embodiments provide a QNN classifier that can be used in resource constrained environments such as NISQ devices. Moreover, one or more of these advantages may be obtained while nonetheless achieving a high degree of accuracy. Accordingly, an efficient, cost-effective classifier is disclosed herein that is suitable for a wide range of computing environments without substantially sacrificing accuracy.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-15. (canceled)

16. A method, implemented by a computing system, the method comprising:
encoding input data into a plurality of physical qubits using an encoding circuit of a Quantum Neural Network (QNN), the encoding circuit comprising a Y-rotation gate directly followed by a phase gate, the encoding circuit having a circuit depth of two;
executing a variational ansatz circuit on the physical qubits to generate a classification prediction for at least some of the input data, the variational ansatz circuit comprising a plurality of parameterized gates;
reducing a dimensionality of the input data such that a circuit depth of the variational ansatz circuit is reduced below a suitability threshold, wherein the suitability threshold is a circuit depth threshold over which the variational ansatz circuit has a coherence requirement on the physical qubits that cannot be met by a Noisy Intermediate Scale Quantum (NISQ) device.

17. The method of claim 16, wherein encoding the input data into the plurality of physical qubits comprises encoding two features of the input data for each qubit in the plurality of physical qubits.

18. The method of claim 16, further comprising constructing the variational ansatz circuit by combining a first variational ansatz circuit and a second variational ansatz circuit.

19. The method of claim 18, wherein the variational ansatz circuit has a higher expressibility than each of the first and second variational ansatz circuits individually.

20. The method of claim 18, wherein the variational ansatz circuit has a higher entangling capability than each of the first and second variational ansatz circuits individually.

21. The method of claim 16, further comprising training the QNN to enhance a plurality of parameters used by the parameterized gates of the variational ansatz circuit to generate the classification prediction.

22. The method of claim 21, wherein training the QNN to enhance the plurality of parameters used by the parameterized gates of the variational ansatz circuit comprises iteratively updating the parameters using a gradient descent to reduce a cost of the parameters.

23. The method of claim 22, wherein gradient descent comprises not more than three hyperparameters.

24. The method of claim 16, wherein the computing system comprises an NISQ device.

25. A computing system comprising:
processing circuitry and a memory, the memory containing instructions executable by the processing circuitry whereby the computing system is configured to:
encode input data into a plurality of physical qubits using an encoding circuit of a Quantum Neural Network (QNN), the encoding circuit comprising a Y-rotation gate directly followed by a phase gate, the encoding circuit having a circuit depth of two;
execute a variational ansatz circuit on the physical qubits to generate a classification prediction for at least some of the input data, the variational ansatz circuit comprising a plurality of parameterized gates;
reduce a dimensionality of the input data such that a circuit depth of the variational ansatz circuit is reduced below a suitability threshold, wherein the suitability threshold is a circuit depth threshold over which the variational ansatz circuit has a coherence requirement on the physical qubits that cannot be met by a Noisy Intermediate Scale Quantum (NISQ) device.

26. The computing system of claim 25, wherein encoding the input data into the plurality of physical qubits comprises encoding two features of the input data for each qubit in the plurality of physical qubits.

27. The computing system of claim 25, further configured to construct the variational ansatz circuit by combining a first variational ansatz circuit and a second variational ansatz circuit.

28. The computing system of claim 27, wherein the variational ansatz circuit has a higher expressibility than each of the first and second variational ansatz circuits individually.

29. The computing system of claim 27, wherein the variational ansatz circuit has a higher entangling capability than each of the first and second variational ansatz circuits individually.

30. The computing system of claim 25, further configured to train the QNN to enhance a plurality of parameters used by the parameterized gates of the variational ansatz circuit to generate the classification prediction.

31. The computing system of claim 30, wherein training the QNN to enhance the plurality of parameters used by the parameterized gates of the variational ansatz circuit comprises iteratively updating the parameters using a gradient descent to reduce a cost of the parameters.

32. The computing system of claim 31, wherein gradient descent comprises not more than three hyperparameters.

33. The computing system of claim 25, wherein the computing system comprises an NISQ device.

34. A non-transitory computer readable medium storing a computer program product comprising instructions which, when executed on processing circuitry of a computing system, configure the processing circuitry to:
encode input data into a plurality of physical qubits using an encoding circuit of a Quantum Neural Network (QNN), the encoding circuit comprising a Y-rotation gate directly followed by a phase gate, the encoding circuit having a circuit depth of two;
execute a variational ansatz circuit on the physical qubits to generate a classification prediction for at least some of the input data, the variational ansatz circuit comprising a plurality of parameterized gates;
reduce a dimensionality of the input data such that a circuit depth of the variational ansatz circuit is reduced below a suitability threshold, wherein the suitability threshold is a circuit depth threshold over which the variational ansatz circuit has a coherence requirement on the physical qubits that cannot be met by a Noisy Intermediate Scale Quantum (NISQ) device.
